(19) United States
(12) Patent Application Publication
(10) Pub. No.: US 2015/0159715 A1
(43) Pub. Date: Jun. 11, 2015

(54) BRAKE PADS FOR A VEHICLE BRAKING ASSEMBLY

(71) Applicant: Bendix Commercial Vehicle Systems LLC, Elyria, OH (US)

(72) Inventor: Ronald S. Plantan, Mooresville, NC (US)

(73) Assignee: Bendix Commercial Vehicle Systems LLC, Elyria, OH (US)

(21) Appl. No.: 14/099,526

(22) Filed: Dec. 6, 2013

(51) Int. Cl. F16D 65/827

(52) U.S. Cl. CPC F16D 65/827

(57) ABSTRACT

A brake pad is used in a drum brake. The brake pad includes a frictional material engaging a housing of an associated brake drum when it is desired to slow an associated vehicle. A slot is positioned to create airflow in a single direction across the brake pad. A channel extends through a top surface and a bottom surface of the brake pad.

### BACKGROUND

The present invention relates to a vehicle braking assembly. It finds particular application in conjunction with brake pads for the braking assembly and will be described with particular reference thereto. It will be appreciated, however, that the invention is also amenable to other applications.

Vehicles, including heavy vehicles, typically include drum brakes. Vehicle drum brakes include friction elements such as frictional brake pads. When it is desirable to decelerate the vehicle, the brake pads are positioned to engage a drum surface.

Friction between the brake pads and the vehicle drum help slow the vehicle. Heat and gasses created by the friction between the brake pads and the drum tends to degrade the brake pads over time. It is desirable to introduce cooling air (e.g., atmospheric air) to the brake pads to reduce the heat.

The present invention provides a new and improved vehicle braking apparatus which addresses the above-referenced problems.

### SUMMARY

In one aspect of the present invention, it is contemplated that a brake pad is used in a drum brake. The brake pad includes a frictional material engaging a housing of an associated brake drum when it is desired to slow an associated vehicle. A slot is positioned to create airflow in a single direction across the brake pad. A channel extends through a top surface and a bottom surface of the brake pad.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic representation of a simplified component diagram of an exemplary brake drum assembly in accordance with one embodiment of an apparatus illustrating principles of the present invention;

FIG. 2 illustrates a schematic representation of a perspective view of a drum housing in accordance with one embodiment of an apparatus illustrating principles of the present invention;

FIG. 3 illustrates a schematic representation of a braking assembly in accordance with one embodiment of an apparatus illustrating principles of the present invention;

FIG. 4 illustrates a schematic representation of a side view of the brake drum assembly in accordance with one embodiment of an apparatus illustrating principles of the present invention; and

FIG. 5 illustrates a schematic representation of a front view of brake pads in accordance with one embodiment of an apparatus illustrating principles of the present invention.

### DETAILED DESCRIPTION OF ILLUSTRATED EMBODIMENT

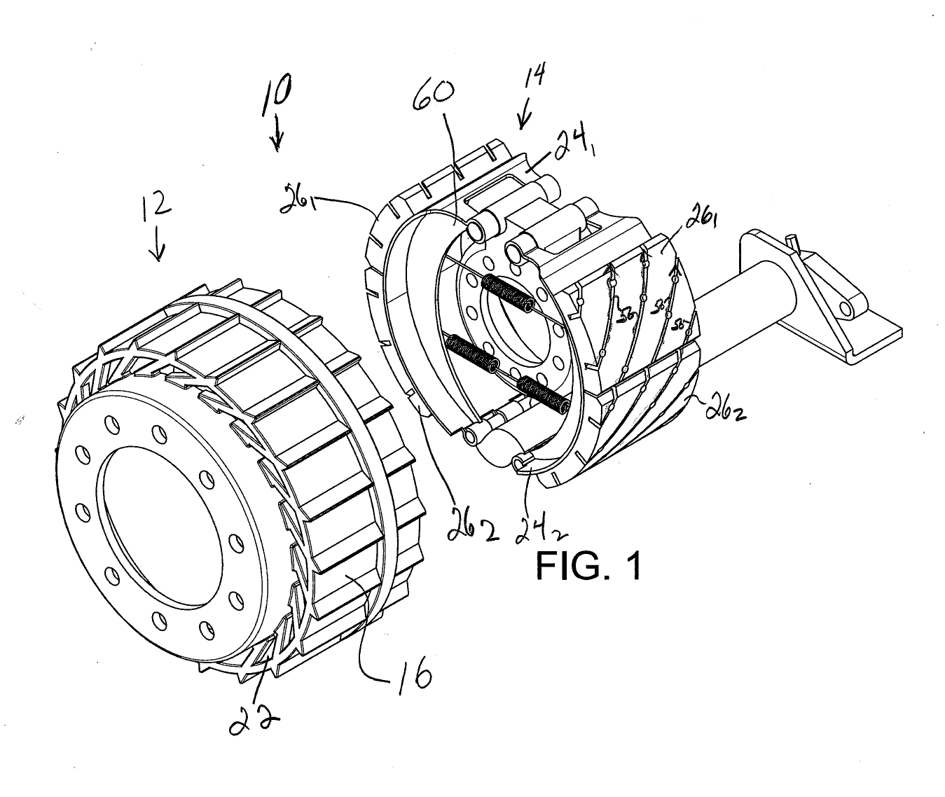

With reference to FIG. 1, a simplified component diagram of an exemplary brake drum assembly 10 is illustrated in accordance with one embodiment of the present invention. The drum assembly 10 includes a drum housing 12 and a brake assembly 14. The drum housing 12 is generally circular. The drum housing 12 includes an exterior surface 16 and vents 22 for exchanging air between an inside of the drum housing 12 and atmosphere. Alternatively, the drum housing 12 may not include vents. Furthermore, in another embodiment, the brake drum assembly 10 may include a means for pulling in air from outside the brake drum assembly 10 area to maintain cooler air flowing through the brake drum assembly 10.

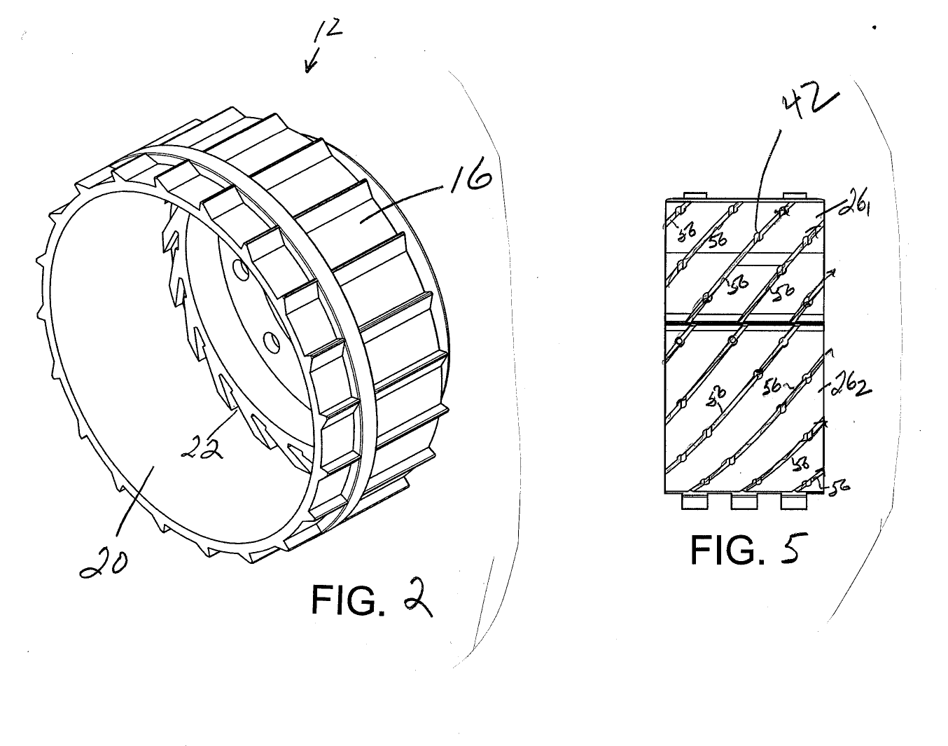

FIG. 2 illustrates a perspective view of the drum housing 12. With reference to FIG. 2, the drum housing 12 also includes an interior surface 20. The exterior surface 16 and vents 22 are also illustrated.

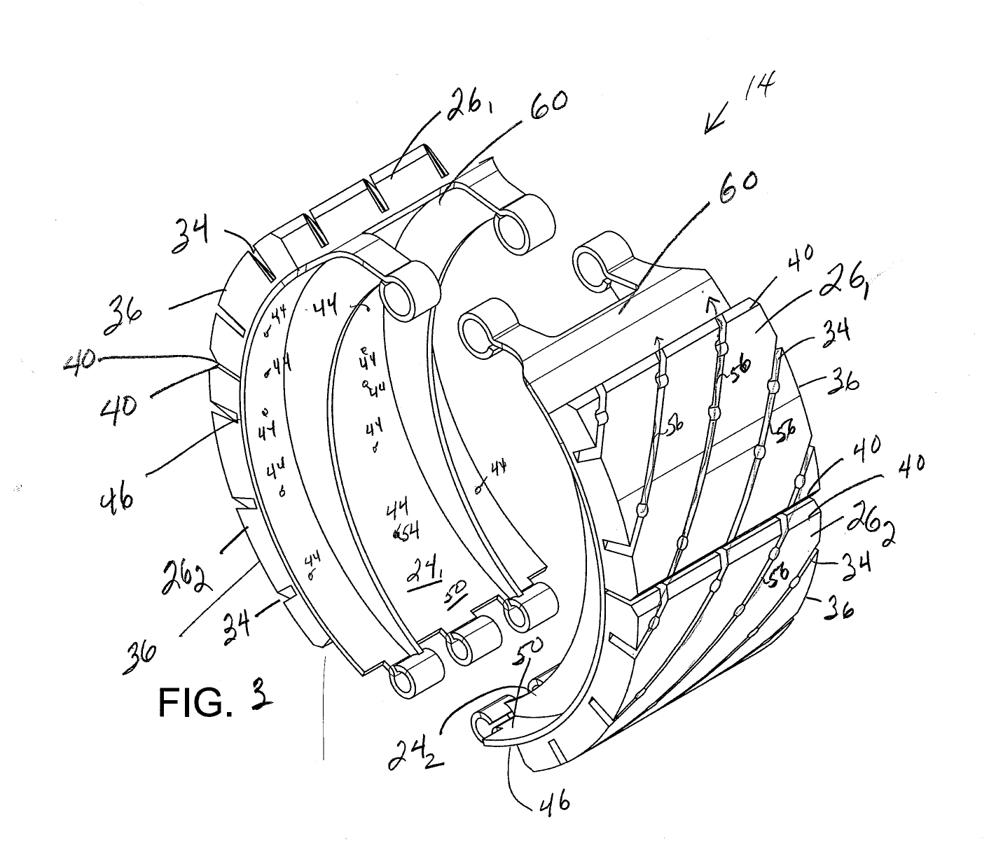

With reference to FIG. 3, the brake assembly 14 includes at least one brake shoe 24 and a braking material 26 secured to the shoe 24. The brake shoe 24 generally comprises a table and a set of two webs.

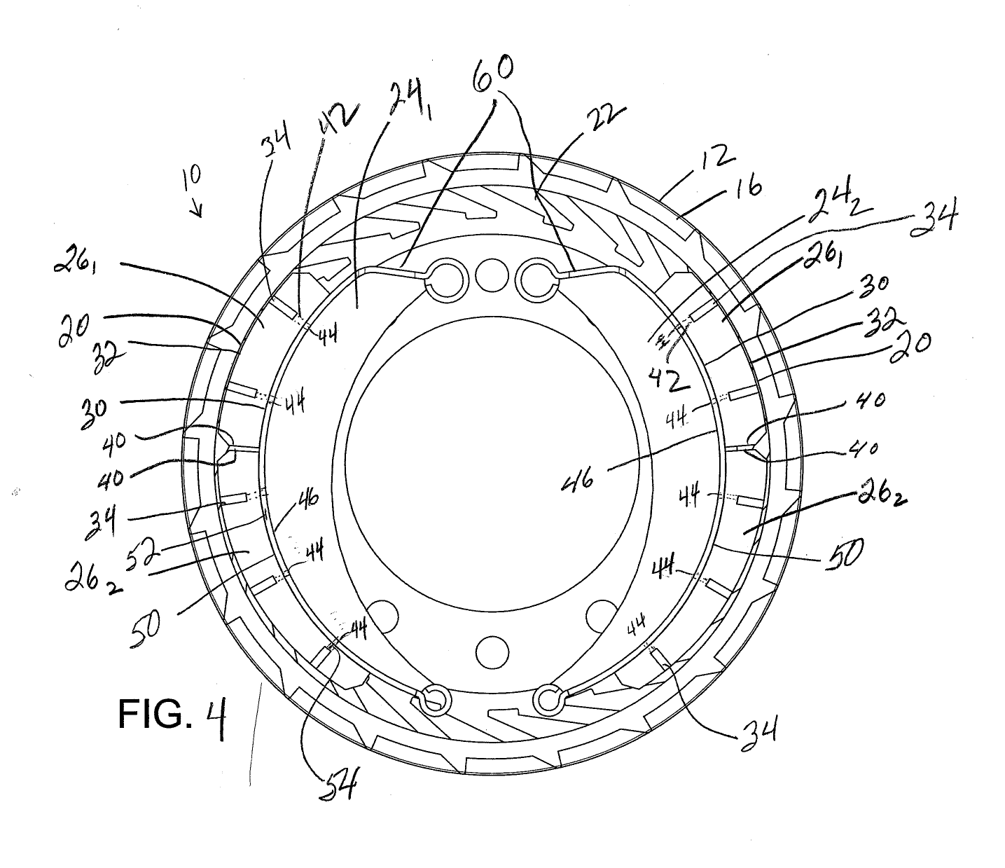

With reference to FIG. 4, in one embodiment, the braking material 26 is a brake pad having an inner (e.g., bottom) surface 30 secured to the brake shoe 24. The brake pad 26 is a frictional material having an outer (e.g., top) surface 32 that acts as a braking surface and engages the interior surface 20 of the brake drum housing 12 when it is desired to slow an associated vehicle. The frictional material 26 is generally on the outer surface of the table of the brake shoe 24. As discussed in more detail below, the brake assembly 14 is illustrated as including two (2) brake shoes 24_{1,2} and two (2) brake pads 26_{1,2} on each of the respective brake shoes 24_{1,2}. The brake pad 26₁ is referred to as an upper brake pad, and the brake pad 26₂ is referred to as a lower brake pad.

With reference again to FIG. 3, each of the brake pads 26_{1,2} includes at least one (1) slot 34 (e.g., groove). In the illustrated embodiment, the brake pad 26₁ includes five (5) slots 34. The brake pad 26₂ may include more or less slots 34 than the brake pad 26₁. However, any number of slots 34 (as long as there is at least one (1) slot) is included on the brake pads 26_{1,2}.

Each of the slots 34 are angled with respect to a side edge 36 of the respective brake pad 26_{1,2}. For example, it is contemplated that each slot 34 is angled between about 10° and about 80° with respect to the side edge 36 of the respective brake pad 26_{1,2}. In the illustrated embodiment, each of the slots 34 is angled at about 45° with respect to the side edge 36 of the respective brake pad 26_{1,2}.

For reasons discussed in more detail below, each of the slots 34 on a respective one of the brake pads 26_{1,2} is substantially parallel to the other slots on that brake pad 26_{1,2}. Furthermore, as best seen in FIGS. 3 and 4, at least one end edge 40 of each of the brake pads 26_{1,2} is beveled. In the illustrated embodiment, both end edges 40 of the brake pads 26_{1,2} are beveled.

With reference to FIGS. 3 and 5, the slots 34 extending to the end edge 40 of the first brake pad 26₁ are collinear with a corresponding one of the slots 34 at an end edge 40 of the second brake pad 26₂.

With reference to FIGS. 4 and 5, at least one channel 42 passes from the outer braking surface 32 of each respective brake pad 26_{1,2} to the inner surface 30. In other words, the channels 42 are holes passing through the brake pads 26_{1,2}. Each of the channels 42 is positioned in one of the slots 34. In other words, groups of the channels 42 are positioned in different slots 34. Since the channels 42 are positioned in the slots 34 in the illustrated embodiment, the channels 42 pass air from the bottom surface 30 to the top surface 30 of the brake pad 26 defined in the respective slot 34.

Each of the brake shoes 24 includes at least one passage 44. Each passage 44 passes through both an outer surface 46 of the shoe 24 and an inner surface 50 of the shoe 24. It is contemplated that each of the brake shoes 24 includes at least as many passages 44 as channels 42 in the corresponding brake pad 26 that is secured to the shoe 24. It is further contemplated that each of the channels 42 in each of the pads 26 is aligned with a respective one of the passages 44 in the corresponding shoe 24 to which the brake pad 26 is attached. Although each of the channels 42 is illustrated as being positioned in one of the slots 34, other embodiments, in which at least some of the channels 42 are not positioned in a slot 34, are also contemplated.

Each of the brake pads 26_{1,2} is secured to a respective brake shoe 24 via at least one of an adhesive 52 and fastener 54 (e.g., a bolt). For example, if an adhesive is used, the adhesive 52 is applied to at least one of the inner surface 30 of the pad 26 and the outer surface 46 of the brake shoe 24. The inner surface 30 of the pad 26 is then applied to the outer surface 46 of the brake shoe 24 so that the channels 42 of the brake pad 26 align with the passages 44 of the brake shoe 24. At least one fastener 54 (e.g., a bolt) may also be passed through the respective aligned channels 42 of the pad 26 and the corresponding passages 44 of the shoe 24 to secure the pad 26 and the shoe 24 together. In one embodiment, the bolt 54 is a rivet. It is to be understood that an adhesive 52, a bolt 54, or both may be used to secure the pad 26 and the shoe 24 together. Other ways of securing the pad 26 and the shoe 24 together are, of course, contemplated. Another aspect of the brake assembly 14 is that the passages 44 of the shoe 24 are in the same place as the rivet holes that are used for securement of the pad 26 to the shoe 24.

It is contemplated that each of the slots 34 has a depth extending from about ¼″ above the outer surface 46 of the brake shoe 24 to a top of the brake pad 26 and a width of about ¼″ to about ½″. However, other dimensions of the slots 34 are also contemplated. In the illustrated embodiment, the slots 34 do not go through the entire friction material 26, whereas the channels 42 do. The visibility of the slots 34 also gives a mechanic a visual indication of how much wearable brake pad life is left, as the slots 34 would not be visible if there is less than about ¼″ of total brake pad material 26 remaining on the shoe 24.

The slots 34 and channels 42 of each pad 26_{1,2} along with the passages 44 of the respective shoe 24 that are aligned with the channels 42, and which are not obstructed by either adhesive 52 or a bolt 54, act as a means for cooling the respective brake pads 26_{1,2} and, additionally, as a means for removing gasses that build-up on the brake pads 26_{1,2} during use. For example, when the brake assembly 14 is secured in the drum housing 12, the brake assembly 14 rotates with the drum housing 12. In other words, as the brake drum assembly 10 rotates with, for example, a wheel of an associated vehicle, the brake assembly 14 rotates in the same direction as the drum housing 12.

As the brake drum assembly 10 rotates, atmospheric air is drawn into the drum assembly 10 via the vents 22. Since the frictional material of the brake pads 26_{1,2} creates heat and gasses as the brake pads 26_{1,2} contact the interior surface 20 of the drum housing 12 during braking applications, the atmospheric air is assumed to cooler than the brake pads 26_{1,2}. The cooler atmospheric air in the brake drum housing 12 is then drawn through the open passages 44 of the brake shoe 24 (e.g., the passages 44 of the brake shoe 24 that are not obstructed by either adhesive 52 or a bolt 54) and the channels 42 of the brake pads 26_{1,2}.

From the channels 42 of the brake pads 26_{1,2}, the air passes through the slots 34. Because all of the slots 34 are angled with respect to the side edge 36 of the brake pad 26 and, furthermore, because all of the slots 34 are substantially parallel to each other, the air entering the slots 34 from the channels 42 flows in a single direction 56 (see FIGS. 1, 3, and 5) through each of the slots 34. The air flowing through the slots 34 acts to cool the brake pads 26_{1,2}. The air flowing through the slots 34 also acts to remove gasses that tend to build-up on the surface of the brake pads 26_{1,2} during braking events. Therefore, the air passes through the aligned channel 42 and passage 44 for at least one of i) cooling the brake pad 26 and the drum housing 12 by flowing relatively cooler air through the passages 44 from the inner surface 50 of the shoe 24 to the outer surface 46 of the shoe 24 and the drum housing 12 and ii) venting gas from the braking surface 32 of the brake pad 26.

The single direction 56 (see FIGS. 1, 3, and 5) of airflow is based on a direction the drum housing 12 is rotating along with the direction and angle of the slots 34 in the brake pads 26. The flow of the atmospheric air through the slots 34 acts to cool the brake pads 26.

The beveled end edges 40 of the brake pads 26_{1,2} allows the airflow from the slot 34 of one of the brake pads 26₁ to pass across the beveled edges 40 of adjacent brake pads 26_{1,2} and into a corresponding slot 34 of the adjacent brake pad 26₂. Therefore, the beveled end edges 40 of the brake pads 26 acts as a means for extending the airflow path to one of the side edges 36 of a brake pad 26.

Cooling the brake pads 26 and/or exhausting gasses from braking events results in extended life and, consequently, reduced maintenance cost for vehicle brakes.

With reference to FIG. 5, the first (upper) brake pad 26₁ is relatively smaller than the second (lower) brake pad 26₂. It is contemplated that the second (lower) brake pad 26₂ includes a frictional material that has a relatively higher braking performance than the first (upper) brake pad 26₁. In the illustrated embodiment, the first (upper) brake pad 26₁ is positioned proximate to a cam end 60 (see FIGS. 1, 3, and 4) of the brake shoes 24_{1,2}.

The relatively higher performance frictional material of the second (lower) brake pad 26₂ is harder than frictional material used in standard braking pads. The harder material tends to cause vibration and noise when contacting the inner surface 20 of the drum housing 12 during lighter braking applications. Therefore, the second (lower) brake pad 26₂ including the harder, relatively higher performing frictional braking material is not positioned at the cam end 60 (see FIGS. 1, 3, and 4) of the brake shoe 24. Positioning the softer standard performing frictional braking material of the first (upper) brake pad 26₁ near the cam end 60 (see FIGS. 1, 3, and 4) of the brake shoe 24 helps reduce vibration and noise during braking applications (e.g., during lighter braking applications).

As noted above, in the illustrated embodiment the first (upper) brake pad 26₁ is relatively smaller than the second (lower) brake pad 26₂. For example, the first (upper) brake pad 26₁ is between about ¼ to about ⅓ the size of the second (lower) brake pad 26₂ as measured between the respective end edges 40 of the brake pads 26. Therefore, the first (upper) brake pad 26₁ covers about ¼ to about ⅓ of the brake shoe 24 and the second (lower) brake pad 26₂ covers about ⅔ to about ¾ of the brake shoe 24. Including a relatively smaller brake pad 26₁ of standard braking material and a relatively larger brake pad 26₂ of relatively higher performing braking material acts as a means for increasing braking performance without substantially increasing vibration during braking.

As discussed above, both of the brake pads 26_{1,2} include the slots 34 and beveled end edges 36 to help improve cooling of the brake pads 26_{1,2} and reduce gas build-up along the braking surfaces 32 of the brake pads 26_{1,2}.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. A brake pad for use in a drum brake, the brake pad comprising:
a frictional material engaging a housing of an associated brake drum when it is desired to slow an associated vehicle;
a slot positioned to create airflow in a single direction across the brake pad; and
a channel through a top surface and a bottom surface of the brake pad.

2. The brake pad as set forth in claim 1, wherein:
the slot is angled at about 45° with respect to an edge of the brake pad.

3. The brake pad as set forth in claim 1, wherein:
the slot is angled between about 10° and about 80° with respect to an edge of the brake pad.

4. The brake pad as set forth in claim 1, wherein:
the slot has a depth extending from about ¼″ above an outer surface of the brake shoe to a top of the brake pad; and
the slot has a width between about ¼″ and about ½″.

5. The brake pad as set forth in claim 1, wherein:
the top surface of the brake pad is a braking surface; and
the channel passes air to the braking surface of the brake pad.

6. The brake pad as set forth in claim 5, wherein:
the channel is positioned in the slot; and
the channel passes air from the bottom surface to the top surface of the brake pad defined in the slot.

7. The brake pad as set forth in claim 1, further including:
at least one additional slot.

8. The brake pad as set forth in claim 7, wherein:
each of the slots is angled at about 45° with respect to an edge of the brake pad.

9. The brake pad as set forth in claim 8, wherein:
each of the slots is substantially parallel to each other.

10. The brake pad as set forth in claim 7, further including:
at least one additional channel through a top and bottom surface of the brake pad; and
wherein each of the channels passes air from the bottom surface to the top surface of the brake pad defined in the slot.

11. A brake drum system for a vehicle, the system comprising:
a drum housing;
a shoe positioned in the drum housing, the shoe including a plurality of passages through both an outer surface of the brake shoe and an inner surface of the brake shoe;
a first brake pad secured on the shoe, the first brake pad including:
a first frictional material engaging the drum housing when it is desired to slow the vehicle;
a first slot positioned to create airflow in a single direction across the first brake pad; and
a first channel through a top surface of the first brake pad and a bottom surface of the first brake pad, the first channel being aligned with one of the passages.

12. The brake drum system as set forth in claim 11, wherein:
the top surface of the first brake pad is a braking surface; and
air passes through the aligned first channel and passage for at least one of i) cooling the first brake pad and the drum housing by flowing relatively cooler air through the passages from the inner surface of the shoe to the outer surface of the shoe and the drum housing and ii) venting gas from the braking surface of the first brake pad.

13. The brake drum system as set forth in claim 11, further including:
at least one additional channel through the top and bottom surface of the first brake pad;
wherein each of the additional channels is aligned with a respective one of the passages.

14. The brake drum system as set forth in claim 13, further including:
a fastener passing through at least one of the aligned channels and respective passages;
wherein air passes through at least one of the aligned channels and respective passages for cooling the first brake pad.

15. The brake drum system as set forth in claim 14, further including:
at least one additional slot;
groups of the channels are positioned in respective ones of the slots.

16. The brake drum system as set forth in claim 15, wherein:
each of the slots is substantially parallel to the other slots; and
each of the slots is positioned to create the airflow in the single direction across the first brake pad;
the airflow passes through each of the slots in the single direction.

17. The brake drum system as set forth in claim 11, wherein:
the first channel is positioned in the first slot; and
air passes through the aligned channel and passage in the slot for cooling the first brake pad.

18. The brake drum system as set forth in claim 17, wherein:
the single direction of airflow across the first brake pad is based on a direction of the drum housing is rotating.

19. The brake drum system as set forth in claim 11, further including:
a second brake pad secured on the shoe, the second brake pad including:
a second frictional material engaging the drum housing when it is desired to slow the vehicle, the second frictional material having a relatively higher braking performance than the first brake pad;
a second brake pad slot positioned to create the airflow in the single direction across the second brake pad; and
a second channel through a top surface of the second brake pad and a bottom surface of the second brake pad, the second channel being aligned with one of the passages.

20. The brake drum system as set forth in claim 19, wherein:
the second brake pad includes a second slot positioned to create the airflow in the single direction across the second brake pad.

21. The brake drum system as set forth in claim 19, wherein:
the first brake pad is smaller than the second brake pad; and
the first brake pad is positioned closer to a cam end of the shoe than the second brake pad.

22. A brake pad assembly for use in a drum brake, the brake pad assembly comprising:
a shoe;
a first brake pad secured to the shoe;
a second brake pad secured to the shoe, the second brake pad having a relatively higher braking performance than the first brake pad;
slots positioned in the first and second brake pads to create airflow in a single direction across the first and second brake pads; and
channels through respective top surfaces and bottom surfaces of the first and second brake pads.

23. The brake pad assembly as set forth in claim 22, wherein:
the first brake pad is closer to a cam end of the shoe than the second brake pad.

24. The brake pad assembly as set forth in claim 23, wherein:
the second brake pad is larger than the first brake pad.

25. The brake pad assembly as set forth in claim 24, wherein:
the first brake pad covers between about ¼ to about ⅓ of an exterior surface of the shoe; and
the second brake pad covers ⅔ and ¾ of the shoe.

26. The brake pad assembly as set forth in claim 22, wherein:
the slots are substantially parallel;
the slots are angled between about 10° and about 80° with respect to respective edges of the first and second brake pads; and
at least one of the slots in the first brake pad is collinear with a corresponding one of the slots in the second brake pad.

27. A brake pad assembly for use in a drum brake, the brake pad assembly comprising:
a shoe;
a first brake pad secured to the shoe;
a second brake pad secured to the shoe;
means for increasing braking performance without substantially increasing braking vibration; and
means for cooling the first and second brake pads.

28. The brake pad assembly as set forth in claim 27, wherein the means for increasing braking performance without substantially increasing braking vibration includes:
the first brake pad being smaller than the second brake pad.

29. The brake pad assembly as set forth in claim 28, wherein the means for increasing braking performance without substantially increasing braking vibration further includes:
the first brake pad being positioned closer to a cam end of the shoe than the second brake pad.

30. The brake pad assembly as set forth in claim 27, wherein the means for cooling the first and second brake pads includes:
slots positioned in the first and second brake pads to create airflow in a single direction across the first and second brake pads.

31. The brake pad assembly as set forth in claim 30, wherein the means for cooling the first and second brake pads further includes:
a plurality of channels positioned in the slots and though the first and second brake pads;
wherein air passes from an inside surface of the shoe to the slots via the channels; and
wherein the air passes along the slots in the single direction for cooling the first and second brake pads.
